(19) United States
(12) Patent Application Publication
(10) Pub. No.: US 2024/0169531 A1
(43) Pub. Date: May 23, 2024

(54) MEDICAL IMAGE PROCESSING APPARATUS, MEDICAL IMAGE PROCESSING METHOD, AND MODEL GENERATION METHOD

(71) Applicant: CANON MEDICAL SYSTEMS CORPORATION, Otawara-shi (JP)

(72) Inventor: Masakazu MATSUURA, Nasushiobara (JP)

(73) Assignee: CANON MEDICAL SYSTEMS CORPORATION, Otawara-shi (JP)

(21) Appl. No.: 18/507,148

(22) Filed: Nov. 13, 2023

(30) Foreign Application Priority Data
Nov. 18, 2022 (JP) 2022-185040

(51) Int. Cl. G06T 7/00; G06T 5/00; G06T 11/00

(52) U.S. Cl. CPC G06T 7/0012; G06T 5/002; G06T 11/008; G06T 2207/10081

(57) ABSTRACT

A medical image processing apparatus according to one embodiment includes processing circuitry. The processing circuitry acquires second image data in which a low count artifact is reduced, by applying a trained machine learning model to first image data that is obtained by X-ray CT scan. The processing circuitry outputs image data based on the second image data. The machine learning model is trained by using training data that includes third image data and fourth image data, where the third image data is reconstructed based on projection data that is obtained by X-ray CT scan and the fourth image data is based on the projection data and includes a generated low count artifact.

### CROSS-REFERENCE TO RELATED APPLICATIONS

This application is based upon and claims the benefit of priority from Japanese Patent Application No. 2022-185040, filed on Nov. 18, 2022, the entire contents of which are incorporated herein by reference.

### FIELD

Embodiments described herein relate generally to a medical image processing apparatus, a medical image processing method, and a model generation method.

### BACKGROUND

Conventionally, in X-ray Computed Tomography (CT), at the time of low-dose image capturing and at the time of image capturing at a certain site, such as a shoulder or a pelvis, at which X-ray absorption is large, count of collected data may be reduced (low count). In the X-ray CT image capturing with low count as described above, a dark band artifact or a streak artifact may occur and accuracy of a CT value may be reduced on a reconstructed medical image. In this case, interpretation of the medical image and diagnosis using the medical image may be adversely affected.

Further, as a conventional method, there is a known method in which, when collected data (count number) indicating count of X-ray photons is to be converted to attenuation count data, and if the count number is smaller than a certain threshold value, the collected data is converted to the attenuation count data by using a tangent of a logarithmic curve (approximate formula) instead of the logarithmic curve. If noise is not mixed with the collected data, the collected data of X-ray CT, that is, the count number does not have a negative value. However, actual collected data that is collected by X-ray CT includes noise, so that the collected data may have a negative value in some cases. There is a known method of rounding up the count of the negative value to zero or adopting an absolute value of the count number of the negative value based on the assumption that “a negative value is not taken”.

In the conventional method, if the collected data (count number) is close to zero or has a negative value when, in particular, ultralow-dose X-ray CT image capturing or the like is performed, it is difficult to fully reduce an artifact and improve accuracy of a CT value.

### BRIEF DESCRIPTION OF THE DRAWINGS

FIG. 1 is a diagram illustrating a configuration example of a PCCT apparatus according to one embodiment;

FIG. 2 is a diagram illustrating an example of first image data according to one embodiment;

FIG. 3 is a flowchart illustrating an example of the flow of an artifact reduction process according to one embodiment;

FIG. 4 is a diagram illustrating an example of first image data, to which an artifact reduction model is not yet applied, and second image data, to which the artifact reduction model is applied, according to one embodiment;

FIG. 5 is a diagram illustrating an example of a training apparatus related to generation of the artifact reduction model according to one embodiment;

FIG. 6 is a diagram illustrating an example of an overview of a process of generating the artifact reduction model and the artifact reduction process according to one embodiment;

FIG. 7 is a diagram illustrating an example of the flow of a process in a low count simulation process according to one embodiment;

FIG. 8 is a flowchart illustrating an example of the flow of a model generation process according to one embodiment;

FIG. 9 is a diagram illustrating an example of two low count artifact images with different sizes and different patterns according to a modification of one embodiment; and

FIG. 10 is a diagram illustrating an example of an overview of a model generation process and an artifact reduction process according to the modification of one embodiment.

### DETAILED DESCRIPTION

A medical image processing apparatus according to one embodiment includes processing circuitry. The processing circuitry acquires second image data in which a low count artifact is reduced, by applying a trained machine learning model to first image data that is obtained by X-ray CT scan. The processing circuitry outputs image data based on the second image data. The machine learning model is trained by using training data including third image data that is reconstructed based on projection data obtained by X-ray CT scan and fourth image data that is based on the projection data and that includes a generated low count artifact.

A medical image processing apparatus, a medical image processing method, a model generation method, and a training data generation method will be described below with reference to the drawings. In the embodiment below, components denoted by the same reference symbols perform the same operation, and repeated explanation will be omitted appropriately. Further, to provide concrete explanation, explanation will be given based on the assumption that the medical image processing apparatus according to one embodiment is mounted on a medical image capturing apparatus. Meanwhile, the medical image processing apparatus according to one embodiment may be implemented by a server apparatus that can implement the medical image processing method, such as a server apparatus that can execute a medical image processing program for implementing the medical image processing method, for example.

Explanation will be given based on the assumption that the medical image processing apparatus is mounted on a Photon Counting Computed Tomography (PCCT) apparatus (hereinafter, referred to as a PCCT apparatus) as one example of the medical image capturing apparatus. Meanwhile, the medical image capturing apparatus on which the present medical image processing apparatus is mounted is not limited to the PCCT apparatus, but may be a nuclear medicine diagnosis apparatus, such as an integral-type X-ray CT apparatus, a Positron Emission Tomography (PET), and a Single Photon Emission Computed Tomography (SPECT), a composite apparatus of the nuclear medicine diagnosis apparatus and the X-ray CT apparatus, an X-ray Angiography apparatus, an X-ray diagnostic apparatus, or the like.

### Embodiment

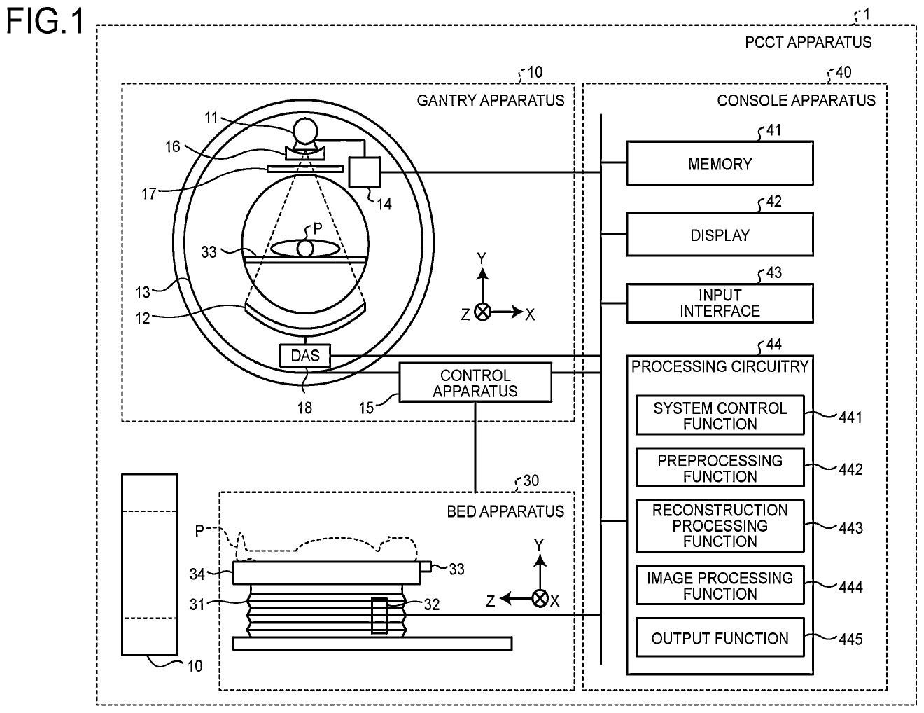

FIG. 1 is a diagram illustrating a configuration example of a PCCT apparatus 1 according to one embodiment. As illustrated in FIG. 1, the PCCT apparatus 1 includes a gantry apparatus 10 that is also referred to as a gantry, a bed apparatus 30, and a console apparatus 40. A medical image processing apparatus according to the present embodiment corresponds to a configuration that is obtained by eliminating a system control function 441, a preprocessing function 442, and a reconstruction processing function 443 from the console apparatus 40 illustrated in FIG. 1, for example. Meanwhile, the medical image processing apparatus according to the present embodiment may be configured by appropriately eliminating unneeded components from the components in the console apparatus 40 illustrated in FIG. 1.

Meanwhile, in the present embodiment, a longitudinal direction of a rotation axis of a rotary frame 13 in a non-tilt state is defined as a Z-axis direction, a direction that is perpendicular to the Z-axis direction and that extends toward a support that supports the rotary frame 13 from a center of rotation is defined as an X axis, and a direction that is perpendicular to the Z axis and the X axis is defined as a Y axis. In FIG. 1, the gantry apparatus 10 is illustrated multiple times for convenience of explanation; however, as an actual configuration of the PCCT apparatus 1, the single gantry apparatus 10 is provided.

The gantry apparatus 10 and the bed apparatus 30 operate based on operation that is performed by an operator via the console apparatus 40 or based on operation that is performed by an operator via an operating unit arranged in the gantry apparatus 10 or the bed apparatus 30. The gantry apparatus 10, the bed apparatus 30, and the console apparatus 40 are communicably connected to one another in a wired or wireless manner.

The gantry apparatus 10 is an apparatus that includes an image capturing system that applies X-rays to the subject P and collects count data (hereinafter, referred to as photon count data) of the X-rays that have transmitted through the subject P. The gantry apparatus 10 includes an X-ray tube 11, an X-ray detector 12, the rotary frame 13, an X-ray high-voltage apparatus 14, a control apparatus 15, a wedge 16, a collimator 17, and a Data Acquisition System (DAS) 18.

The X-ray tube 11 is a vacuum tube that generates X-rays by applying a thermal electron from a cathode (filament) to an anode (target) by application of high voltage and supply of a filament current from the X-ray high-voltage apparatus 14. The X-rays are generated by collision of the thermal electron against the target. The X-rays generated at a tube focus in the X-ray tube 11 transmit through an X-ray radiation window in the X-ray tube 11, are formed in, for example, a cone beam shape via the collimator 17, and are applied to the subject P. The X-ray tube 11 includes, for example, a rotary anode type X-ray tube that generates X-rays by applying a thermal electron to a rotating anode.

The X-ray detector 12 detects photons of the X-rays generated by the X-ray tube 11. Specifically, the X-ray detector 12 detects, in units of photons, the X-rays that are emitted from the X-ray tube 11 and that have transmitted through the subject P, and outputs an electrical signal corresponding to an amount of the X-rays to the DAS 18. That is, the X-ray detector 12 is implemented by a photon counting X-ray detector. The X-ray detector 12 includes a plurality of detection element arrays in each of which a plurality of detection elements (also referred to as X-rays detection elements) in a fan angle direction along a single circular arc about, for example, a focal point of the X-ray tube 11. In the X-ray detector 12, the plurality of detection element arrays are flatly arranged along the Z-axis direction. That is, the X-ray detector 12 has a structure in which, for example, the plurality of detection element arrays are flatly arranged in a cone angle direction (also referred to as a column direction, a row direction, or a slice direction).

Meanwhile, the PCCT apparatus 1 includes various types, such as a Rotate/Rotate-Type (the third-generation CT) in which the X-ray tube 11 and the X-ray detector 12 integrally rotate around the subject P and a Stationary/Rotate-Type (the fourth-generation CT) in which a large number of X-ray detection elements arrayed in a ring manner are fixed and only the X-ray tube 11 rotates around the subject P, and any type is applicable to the present embodiment.

The X-ray detector 12 is an X-ray detector of a direct conversion type that includes a semiconductor element for converting incident X-rays to charges. The X-ray detector 12 of the present embodiment includes, for example, at least a single high voltage electrode, at least a single semiconductor crystal, and a plurality of read-out electrodes. The semiconductor element is also referred to as an X-ray conversion element. The semiconductor crystal is implemented by, for example, cadmium telluride (CdTe), cadmium Zinc telluride (CdZnTe) (CZT), or the like. In the X-ray detector 12, electrodes are arranged on two surfaces that face each other across the semiconductor crystal and that are perpendicular to the Y direction. That is, in the X-ray detector 12, a plurality of anode electrodes (also referred to as read-out electrodes or pixel electrodes) and cathode electrodes (also referred to as common electrodes) are arranged across the semiconductor crystal.

Bias voltage is applied between the read-out electrodes and the common electrodes. In the X-ray detector 12, when the X-rays are absorbed by the semiconductor crystal, an electron-hole pair is generated, an electron moves to the anode side (the anode electrode (read-out electrode) side), and a hole moves to the cathode side (the cathode electrode side), so that a signal related to detection of the X-rays is output from the X-ray detector 12 to the DAS 18.

Meanwhile, the X-ray detector 12 may be a photon counting X-ray detector of an indirect conversion type that indirectly converts incident X-rays to an electrical signal. The X-ray detector 12 is one example of an X-ray detection unit.

The rotary frame 13 is an annular frame that supports the X-ray tube 11 and the X-ray detector 12 such that the X-ray tube 11 and the X-ray detector 12 face each other, and causes the control apparatus 15 (to be described later) to rotate the X-ray tube 11 and the X-ray detector 12. Meanwhile, the rotary frame 13 further includes and supports the X-ray high-voltage apparatus 14 and the DAS 18, in addition to the X-ray tube 11 and the X-ray detector 12. The rotary frame 13 is supported, in a rotatable manner, by a non-rotary portion (for example, a fixed frame (not illustrated in FIG. 1)) of the gantry apparatus 10. A rotation mechanism includes, for example, a motor that generates a rotation driving force and a bearing that transmits the rotation driving force to the rotary frame 13 and rotates the rotary frame 13. The motor is arranged in, for example, the non-rotary portion, the bearing is physically connected to the rotary frame 13 and the motor, and the rotary frame 13 rotates in accordance with a rotation force of the motor.

Communication circuitry of a contactless type or a contact type is arranged in each of the rotary frame 13 and the non-rotary portion, and allows communication between a unit supported by the rotary frame 13 and the non-rotary portion or between the gantry apparatus 10 and an external apparatus. For example, when optical communication is adopted as the contactless communication method, photon count data that is generated by the DAS 18 is transmitted, by the optical communication, from a transmitter that is arranged in the rotary frame 13 and that includes a light emitting diode (LED) to a receiver that is arranged in the non-rotary portion of the gantry apparatus 10 and that includes a photodiode, and further transferred, by the transmitter, from the non-rotary portion to the console apparatus 40. Meanwhile, as the communication method, it may be possible to adopt a contactless-type data transfer method, such as a capacitive coupling method or a radio method, and a contact-type data transfer method. Further, the rotary frame 13 is one example of a rotation unit.

The X-ray high-voltage apparatus 14 includes electrical circuitry, such as a transformer and a rectifier, a high-voltage generator that has a function to generate high voltage to be applied to the X-ray tube 11 and a filament current to be supplied to the X-ray tube 11, and an X-ray control apparatus that controls output voltage corresponding to X-rays applied by the X-ray tube 11. The high-voltage generator may be of a transformer type or an inverter type. Meanwhile, the X-ray high-voltage apparatus 14 may be arranged on the rotary frame 13 or at the side of the fixed frame of the gantry apparatus 10. Further, the X-ray high-voltage apparatus 14 is one example of an X-ray high voltage unit.

The control apparatus 15 includes processing circuitry including a Central Processing Unit (CPU) or the like, and a driving mechanism, such as a motor and an actuator. The processing circuitry includes, as hardware resources, a processor, such as a CPU or a Micro Processing Unit (MPU), and a memory, such as a Read Only Memory (ROM) or a Random Access Memory (RAM). Further, the control apparatus 15 may be implemented by, for example, a processor, such as a Graphics processing Unit (GPU), an Application Specific Integrated Circuit (ASIC), a Programmable Logic Device (for example, a Simple Programmable Logic Device (SPLD)), a Complex Programmable Logic Device (CPLD), and a Field Programmable Gate Array (FPGA)).

If the processor is, for example, a CPU, the processor reads a program that is stored in the memory and executes the program to implement a function. In contrast, if the processor is an ASIC, the function is directly incorporated, as logic circuitry, in circuitry of the processor, instead of storing the program in the memory. Meanwhile, each of the processors of the present embodiment need not always be configured as single circuitry for each of the processors, but it may be possible to construct a single processor by combining a plurality of independent circuitry and implement corresponding functions. Furthermore, it may be possible to integrate a plurality of components into a single processor and implement corresponding functions.

The control apparatus 15 has a function to receive an input single from an input interface that is attached to the console apparatus 40 or the gantry apparatus 10, and control operation of the gantry apparatus 10 and the bed apparatus 30. For example, the control apparatus 15 performs control of rotating the rotary frame 13, control of tilting the gantry apparatus 10, and control of operating the bed apparatus 30 and a tabletop 33 upon receiving the input signal. Meanwhile, the control of tilting the gantry apparatus 10 is realized such that the control apparatus 15 causes the rotary frame 13 to rotate about an axis that is parallel to the X-axis direction based on inclination angle (tilt angle) information that is input through the input interface attached to the gantry apparatus 10.

Meanwhile, the control apparatus 15 may be arranged on the gantry apparatus 10 or may be arranged on the console apparatus 40. Further, the control apparatus 15 may be configured such that a program is directly incorporated in circuitry of the processor, instead of storing the program in the memory. Furthermore, the control apparatus 15 is one example of the control unit.

The wedge 16 is a filter for adjusting an X-ray dose of the X-rays emitted from the X-ray tube 11. Specifically, the wedge 16 is a filter that transmits and attenuates the X-rays emitted from the X-ray tube 11 such that a distribution of the X-rays applied from the X-ray tube 11 to the subject P has a certain form that is determined in advance. The wedge 16 is, for example, a wedge filter or a bow-tie filter, and is a filter that is formed by processing aluminum so as to have a predetermined target angle and a predetermined thickness.

The collimator 17 is a lead plate or the like for condensing the X-rays that have transmitted through the wedge 16 into an X-ray irradiation range, and a slit is formed by combining a plurality of lead plates or the like. Meanwhile, the collimator 17 may also be referred to as an X-ray aperture.

The DAS 18 includes a plurality of counting circuitry. Each counting circuitry includes an amplifier that performs an amplification process on an electrical signal that is output from each of the detection elements of the X-ray detector 12 and an A/D converter that converts the amplified electrical signal to a digital signal, and generates photon count data that is a result of a counting process using the detection signal of the X-ray detector 12. The result of the counting process is data in which the number of photons of the X-rays per energy bin is assigned. The energy bin corresponds to an energy range with a predetermined width. For example, the DAS 18 counts photons (X-ray photons) derived from the X-rays that are emitted by the X-ray tube 11 and that have transmitted through the subject P, and generates, as the photon count data, a result of the counting process by distinguishing energy of the counted photons. The DAS 18 is one example of a data collection unit.

The photon count data that is generated by the DAS 18 is transferred to the console apparatus 40. The photon count data is a set of pieces of data that indicate a channel number and a column number of the detection element that has generated the data, a view number indicating a collected view (also referred to as a projection angle), and a value indicating the dose of the detected X-rays. Meanwhile, as the view number, it may be possible to use a sequence number (collection time) at which the view is collected, or a number (for example, 1 to 1000) that indicates a rotation angle of the X-ray tube 11. Each of the plurality of counting circuitry in the DAS 18 is implemented by, for example, a circuitry group in which circuitry elements capable of generating the photon count data are mounted. Meanwhile, in the present embodiment, the photon count data corresponds to pure raw data that is detected by the X-ray detector 12 and that is not yet subjected to pre-processing. Further, the photon count data may also be referred to as data that is not subjected to pre-processing.

The bed apparatus 30 is an apparatus on which the subject P to be subjected to scanning is placed and which moves the subject P, and includes a pedestal 31, a table driving apparatus 32, the tabletop 33, and a support frame 34. The pedestal 31 is a casing that supports the support frame 34 such that the support frame 34 is movable in a vertical direction. The table driving apparatus 32 is a motor or an actuator that moves the tabletop 33 on which the subject P is placed in a long axis direction of the tabletop 33. The tabletop 33 that is arranged on an upper surface of the support frame 34 is a plate on which the subject P is placed. Meanwhile, the table driving apparatus 32 may move the support frame 34 in the long axis direction of the tabletop 33, in addition to moving the tabletop 33.

The console apparatus 40 includes a memory 41, a display 42, an input interface 43, and processing circuitry 44. Data communication between the memory 41, the display 42, the input interface 43, and the processing circuitry 44 is performed via a bus, for example. Meanwhile, explanation will be given based on the assumption that the console apparatus 40 is separated from the gantry apparatus 10, but the console apparatus 40 or a part of the components of the console apparatus 40 may be included in the gantry apparatus 10.

The memory 41 is implemented by, for example, a semiconductor memory device, such as a RAM or a flash memory, a hard disk, an optical disk, a Solid State Drive (SSD), or the like. The memory 41 stores therein, for example, the photon count data that is output from the DAS 18, the attenuation count data that is generated by the preprocessing function 442, and a reconstructed image that is reconstructed by the reconstruction processing function 443. The reconstructed image is, for example, three-dimensional CT image data (volume data), two-dimensional CT image data, or the like.

The memory 41 stores therein a machine learning model that is applied to first image data that is obtained by X-ray CT scan. The first image data corresponds to data of a reconstructed image that is reconstructed based on the photon count data (hereinafter, referred to as low count data) that is obtained by low dose (for example, low count) CT scan. The low count data corresponds to photon count data that is collected within a range in which a product of a tube current and tube voltage under an image capturing condition is smaller than a predetermined value, for example. Further, the low count data may be photon count data that is included in a range of count numbers corresponding to a range in which a slope (differential value) of an approximation formula of a logarithmic function that is used in logarithmic transformation when the logarithmic transformation is performed on the pure raw data exceeds a predetermined threshold. The logarithmic transformation is a transformation of a parameter using the logarithmic function in which, for example, the Napier's constant number is adopted as a basis, where the parameter represents a ratio of output from a reference detector (Ref) arranged in the X-ray detector 12 and the pure raw data.

The machine learning model that is trained in advance and stored in the memory 41 is applied to the first image data, and generates second image data in which a low count artifact is reduced. The low count artifact is an artifact that appears in the reconstructed image by low dose CT scan that is performed on the subject P. The low count artifact is a dark band artifact and/or a streak artifact that is not dependent on organs of the subject P, for example.

The machine learning model is a trained model that realizes, for example, reduction of an artifact with respect to an input medical image, and is generated by, for example, training on a Deep Neural Network (DNN) that is not yet trained. Meanwhile, depending on a method of generation (training) of the trained model, the machine learning model is able to realize reduction of noise with respect to the input medical image, in addition to the reduction of the artifact.

Generation of the machine learning model (hereinafter, referred to as an artifact reduction model) according to the present embodiment, that is, training (learning) on the DNN that is not yet trained is implemented by, for example, a training apparatus, various kinds of server apparatuses, various kinds of modalities in which medical data processing apparatuses are mounted, or the like. The generated artifact reduction model is output from, for example, an apparatus (training apparatus) that has performed training (learning) on the DNN, and stored in the memory 41. The machine learning model is trained by using training data that includes third image data, which is reconstructed based on projection data that is obtained by X-ray CT scan, and fourth image data, which is based on the projection data and which includes a generated low count artifact. Generation (training) of the artifact reduction model will be described later.

The memory 41 stores therein a program related to execution of each of the system control function 441, the preprocessing function 442, the reconstruction processing function 443, an image processing function 444, and an output function 445 that are executed by the processing circuitry 44. Further, the memory 41 may store therein a machine learning model (hereinafter, referred to as a noise reduction model) that is trained for at least reducing noise. The memory 41 is one example of a storage unit.

The display 42 displays various kinds of information under the control of the output function 445. For example, the display 42 outputs a medical image (CT image) that is generated by the processing circuitry 44, a Graphical User Interface (GUI) for receiving various kinds of operation from the operator, or the like. As the display 42, for example, a Liquid Crystal Display (LCD), a Cathode Ray Tube (CRT) display, an Organic Electro Luminescence Display (OELD), a plasma display, or other arbitrary displays are appropriately applicable.

Meanwhile, the display 42 may further be arranged on the gantry apparatus 10. Furthermore, the display 42 may be of a desktop type or may be configured as a tablet terminal or the like that is able to perform wireless communication with the console apparatus. The display 42 is one example of a display unit.

The input interface 43 receives various kinds of input operation from the operator, converts the received input operation to an electrical signal, and outputs the electrical signal to the processing circuitry 44. For example, the input interface 43 receives, from the operator, a collection condition for collecting the photon count data, a reconstruction condition for reconstructing the CT image data, an image processing condition related to post processing on the CT image data, or the like. The post processing may be performed by either the console apparatus 40 or an external workstation.

Further, the post processing may be performed at the same time by both of the console apparatus 40 and the workstation. The post processing defined herein is a concept that indicates processing on the image that is reconstructed by the reconstruction processing function 443. The post processing includes, for example, Multi Planer Reconstruction (MPR) display of the reconstructed image, rendering of volume data, or the like. As the input interface 43, for example, a mouse, a keyboard, a trackball, a switch, a button, a joystick, a touch pad, a touch panel display, or the like is appropriately applicable.

Meanwhile, in the present embodiment, the input interface 43 is not limited to those including a physical operating part, such as a mouse, a keyboard, a trackball, a switch, a button, a joystick, a touch pad, a touch panel display, or the like. For example, examples of the input interface 43 include electrical signal processing circuitry that receives an electrical signal corresponding to input operation from an external input apparatus that is arranged separately from the subject apparatus and outputs the electrical signal to the processing circuitry 44. Further, the input interface 43 is one example of an input unit. Furthermore, the input interface 43 may be arranged on the gantry apparatus 10. Moreover, the input interface 43 may be configured as a tablet terminal or the like that is able to perform wireless communication with a main body of the console apparatus 40.

The processing circuitry 44 controls entire operation of the PCCT apparatus 1 in accordance with an electrical signal of input operation output from, for example, the input interface 43. For example, the processing circuitry 44 includes, as hardware resources, a processor, such as a CPU, an MPU, or a Graphics Processing Unit (GPU), and a memory, such as a ROM or a RAM. The processing circuitry 44 executes, by the processor that executes a program loaded on the memory of the processing circuitry 44, the system control function 441, the preprocessing function 442, the reconstruction processing function 443, the image processing function 444, and the output function 445. Meanwhile, each of the functions 441 to 445 need not always be implemented by single processing circuitry, but the processing circuitry may be configured with a plurality of independent processors and each of the processors may execute each of the functions 441 to 445 by executing programs.

The system control function 441 controls each of the functions of the processing circuitry 44 based on the input operation that is received from the operator via the input interface 43. Further, the system control function 441 reads the control program that is stored in the memory 41, loads the control program onto the memory in the processing circuitry 44, and controls each of the units of the PCCT apparatus 1 in accordance with the loaded control program. The system control function 441 is one example of a system control unit.

The preprocessing function 442 performs pre-processing, such as a logarithmic transformation process, an offset correction process, a sensitivity correction process between channels, or beam hardening correction, on the photon count data that is output from the DAS 18, and generates attenuation count data. The attenuation count data may also be referred to as raw data. The preprocessing function 442 is one example of a pre-processing unit. Meanwhile, the photon count data (pure raw data) that is not yet subjected to the pre-processing and the raw data that is subjected to the pre-processing may collectively be referred to as projection data.

The reconstruction processing function 443 performs a reconstruction process using a Filtered Back Projection (FBP) method or the like on the attenuation count data that is generated by the preprocessing function 442, and generates CT image data (medical data). The reconstruction process includes various processes, such as various correction processes including scatter correction and beam hardening correction, and application of a reconstruction processing function under a reconstruction condition. Meanwhile, the reconstruction process performed by the reconstruction processing function 443 is not limited to the FBP method, and it may be possible to appropriately use a known process, such as iterative approximation reconstruction or a deep neural network that outputs a reconstructed image upon input of the attenuation count data. The reconstruction processing function 443 stores the reconstructed CT image data in the memory 41. The reconstructed CT image data corresponds to the first image data. The reconstruction processing function 443 is one example of a reconstruction processing unit.

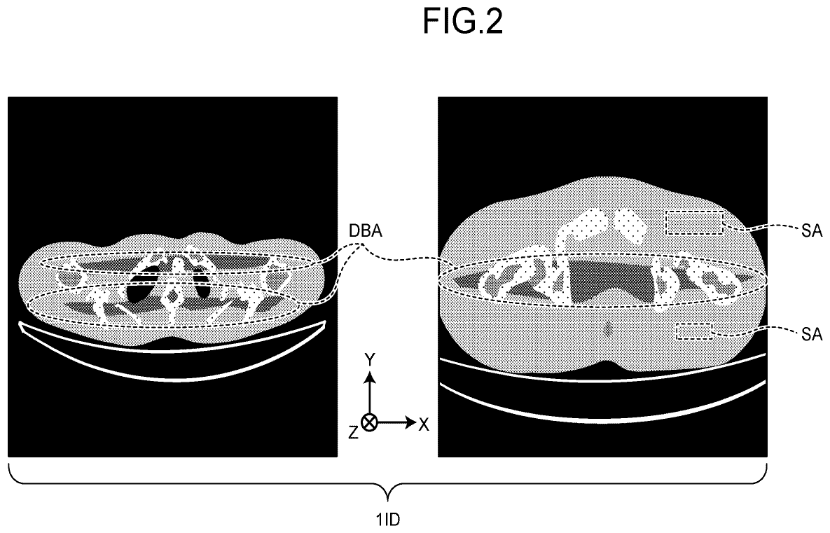

FIG. 2 is a diagram illustrating an example of first image data 1ID. As illustrated in FIG. 2, in the first image data 1ID, dark band artifacts DBA along the X direction and linear streak artifacts SA along the X direction of the first image data 1ID appear due to a thickness of the subject P and a large number of bone portions along the X direction.

The image processing function 444 applies the trained artifact reduction model (machine learning model) to the first image data that is obtained by the X-ray CT scan, and acquires (generates) the second image data in which the low count artifact is reduced. At this time, the image processing function 444 applies the artifact reduction model that is trained for at least reducing noise to the acquired (generated) second image data, and acquires (generates) processed image data in which noise is reduced. Further, if the artifact reduction model has a noise reduction effect, the image processing function 444 inputs the first image data to the artifact reduction model, and acquires, by the artifact reduction model, the second image data in which the low count artifact and the noise are reduced.

The image processing function 444 converts the second image data to tomogram data or three-dimensional image data of an arbitrary cross section by a well-known method based on the input operation that is received from the operator via the input interface 43. Meanwhile, the three-dimensional image data may be directly generated by the reconstruction processing function 443. Further, the image processing function 444 is one example of an image processing unit.

The output function 445 outputs image data based on the second image data. An output destination of the image data is, for example, the memory 41 and/or the display 42. Meanwhile, the output destination of the image data is not limited to the above, and may be an image interpolation server of a PACS or the like. The image data based on the second image data corresponds to image data that is obtained by, for example, performing various kinds of image processing on the second image data by the image processing function 444. Meanwhile, the output function 445 may output the second image data to various output destinations.

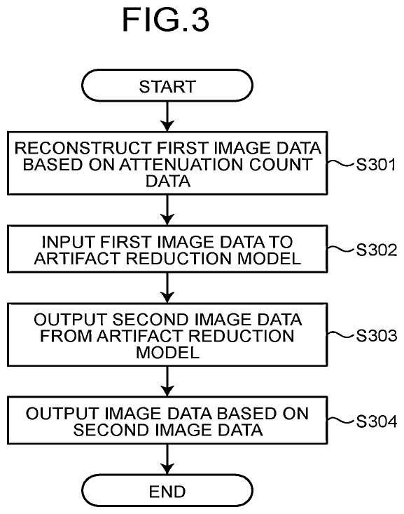

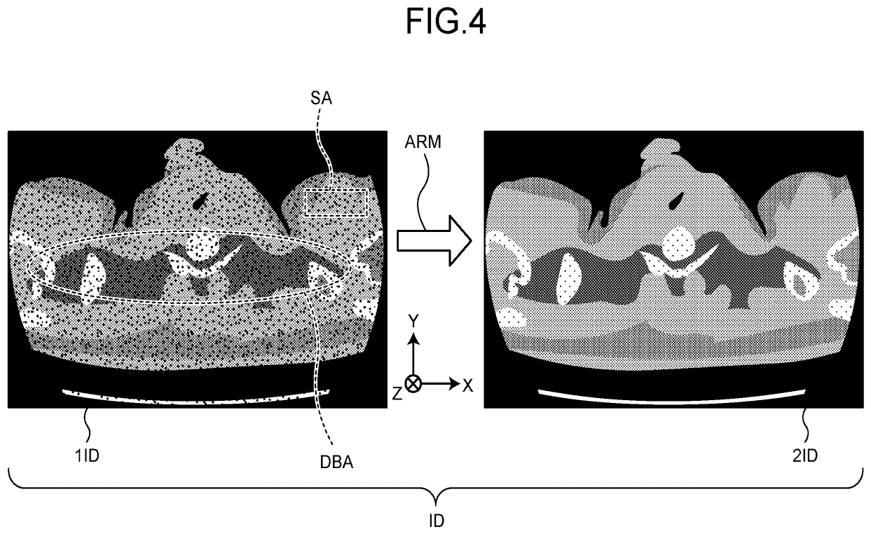

A process (hereinafter, referred to as an artifact reduction process) of generating the second image data from the first image data by using the artifact reduction model in the PCCT apparatus 1 according to the present embodiment configured as described above will be described below with reference to FIG. 3 and FIG. 4.

FIG. 3 is a flowchart illustrating an example of the flow of the artifact reduction process.

Artifact Reduction Process

Step S301

The processing circuitry 44 reconstructs, by the reconstruction processing function 443, the first image data based on the attenuation count data. The reconstruction processing function 443 may store the reconstructed first image data in the memory 41.

Step S302

The processing circuitry 44 reads, by the image processing function 444, the artifact reduction model from the memory 41. The image processing function 444 inputs the first image data to the artifact reduction model.

Step S303

The processing circuitry 44 outputs, by the image processing function 444, the second image data from the artifact reduction model. If the artifact reduction model has the noise reduction function, the second image data is image data in which a low count artifact and noise are reduced. The image processing function 444 stores the second image data in the memory 41. Meanwhile, if the artifact reduction model does not have the noise reduction function, the image processing function 444 reads the noise reduction model from the memory 41. In this case, the image processing function 444 inputs the second image data to the noise reduction model, and generates image data in which the low count artifact and the noise are reduced. Subsequently, the image processing function 444 stores the second image data in the memory 41.

FIG. 4 is a diagram illustrating an example ID of the first image data 1ID to which an artifact reduction model ARM is not yet applied and second image data 2ID to which the artifact reduction model ARM is applied. As illustrated in FIG. 4, in the first image data 1ID, the dark band artifact DBA and the streak artifact SA appear. In contrast, as illustrated in FIG. 4, in the second image data 2ID, the dark band artifact and the streak artifact are reduced as compared to the first image data 1ID. Furthermore, if the artifact reduction model ARM has the noise reduction function, as indicated by the second image data in FIG. 4, noise is also reduced.

Step S304

The processing circuitry 44 generates, by the image processing function 444, image data based on the second image data 21D. The output function 445 outputs the image data based on the second image data 2ID to various output destinations.

The PCCT apparatus 1 according to the embodiment as described above applies the trained machine learning model ARM to the first image data 1ID that is obtained by the X-ray CT scan, acquires the second image data 2ID in which the low count artifact is reduced, and outputs the image data based on the second image data. Further, the PCCT apparatus 1 according to the embodiment acquires, by the machine learning model ARM, the second image data 2ID in which the low count artifact and the noise are reduced. Furthermore, the PCCT apparatus 1 according to the embodiment applies the machine learning model (noise reduction model) that is trained for at least reducing noise to the second image data 2ID, acquires the processed image data in which the noise is reduced, and outputs image data based on the processed image data.

With this configuration, according to the PCCT apparatus 1 of the present embodiment, it is possible to reduce, by the artifact reduction model (trained model), at least an artifact (artifact at the time of low count image capturing) with respect to the first image data that is acquired with low dose. In addition, if the artifact reduction model has the noise reduction function, it is possible to further reduce noise in addition to reducing the artifact. Therefore, according to the PCCT apparatus 1 of the present embodiment, it is possible to increase (improve) accuracy of a CT value due to reduction of the artifact, so that it is possible to improve visibility of an object, such as an anatomical feature, in the second image data and generates a medical image with improved image quality.

Thus, according to the PCCT apparatus 1 of the present embodiment, it is possible to expect improvement of image quality due to reduction of the dark band artifact, reduction of the streak artifact, and improvement in accuracy of the CT value, so that it is possible to contribute to improvement in accuracy of diagnosis of the subject P. Therefore, according to the PCCT apparatus 1 of the present embodiment, it is possible to reduce radiation exposure to the subject P by acquisition of the first image data with low dose, and it is possible to improve throughput of image diagnosis with respect to the subject P.

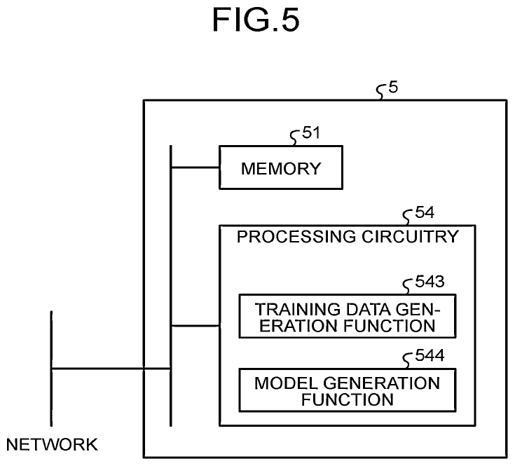

Generation of the machine learning model (artifact reduction model) used in the embodiment will be described below. FIG. 5 is a diagram illustrating an example of a configuration of a training apparatus 5 related to generation of the artifact reduction model. Meanwhile, a function to implement training of the DNN by the training apparatus 5 may be mounted on a medical image capturing apparatus, such as the PCCT apparatus 1, or various kinds of server apparatuses, such as the medical data processing apparatus.

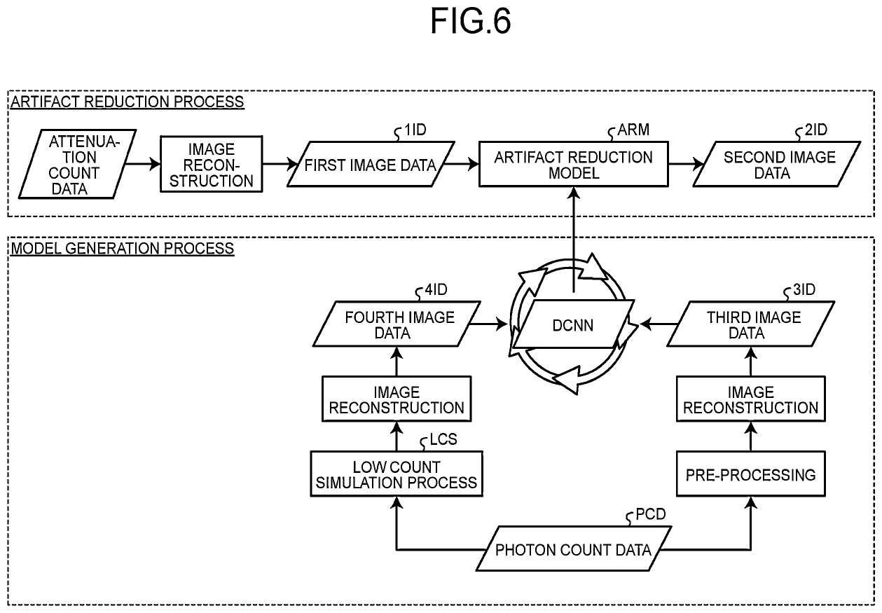

FIG. 6 is a diagram illustrating an example of an overview of a process of generating the artifact reduction model ARM (hereinafter, referred to as a model generation process) and the artifact reduction process. The artifact reduction process illustrated in FIG. 6 is compliant with the description of FIG. 3, and therefore, explanation thereof will be omitted. In the model generation process, a model (DNN) that is not yet subjected to training is trained by using the training data that includes the third image data and the fourth image data. The third image data is data that is reconstructed based on the projection data (photon count data (projection data) PCD) that is obtained by X-ray CT scan. The fourth image data is based on the projection data (the photon count data PCD) and includes a generated low count artifact.

As illustrated in FIG. 6, the fourth image data is image data that is reconstructed after applying a low count simulation process LCS to the photon count data (projection data) PCD, and includes a low count artifact that is artificially generated. That is, the low count simulation process LCS is performed on the photon count data PCD that is pure raw data. The low count simulation process LCS includes a noise addition process and a zero clipping process on a negative value of the photon count data (projection data) PCD. The low count simulation process LCS will be described later.

A memory 51 stores therein a plurality of training data sets, as pairs, that are generated by a training data generation function 543 in processing circuitry 54. The training data set is a set of the third image data and the fourth image data as described above. Further, the memory 51 stores therein original data that is a basis for generation of the training data. The original data is acquired from, for example, a medical image capturing apparatus related to processing target data in the artifact reduction model ARM.

An image (also referred to as a Target image) that is used as a teacher image in generation of the artifact reduction model ARM needs to correspond to the third image data and needs to have high accuracy with respect to the CT value. Therefore, the original data corresponds to the photon count data PCD that is obtained when image capturing is performed with a certain dose equal to or larger than a normal dose with which an adequate count (for example, several hundreds, or the like) can be measured. In generation of the fourth image data, the same data as the photon count data PCD (original data) used for generation of the third image data is used. Therefore, the original data (collected data) that is input to the low count simulation process LCS is also the data for which adequate count is measured.

Further, the memory 51 stores therein the training target DNN and the generated trained model (artifact reduction model) ARM. The memory 51 stores therein a program related to execution of each of the training data generation function 543 and a model generation function 544 implemented by the processing circuitry 54. The memory 51 is one example of a storage unit in the training apparatus 5. Further, hardware that implements the memory 51 is the same as the memory 41 described in the embodiment, and therefore, explanation thereof will be omitted.

The processing circuitry 54 executes, by the processor that executes a program loaded on the memory of the processor, the training data generation function 543 and the model generation function 544. Hardware that implements the processing circuitry 54 is the same as the processing circuitry 44 described in the embodiment, and therefore, explanation thereof will be omitted.

The training data generation function 543 acquires, for example, the photon count data (projection data) that is obtained by the X-ray CT scan on phantom or the like, that is, the original data from the memory 51. Meanwhile, the original data need not always be acquired from the memory 51, but may be acquired from the PCCT apparatus or the like via a network. The training data generation function 543 performs the low count simulation process LCS on the original data, and generates low count data in which the count number in the original is reduced and in which noise is reduced. The low count simulation process LCS will be described below.

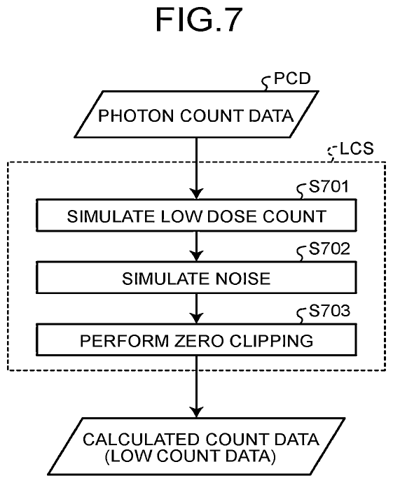

FIG. 7 is a diagram illustrating an example of the flow of the low count simulation process LCS. When performing the low count simulation process LCS, the training data generation function 543 inputs the photon count data PCD as the original data to the low count simulation process LCS.

Low Count Simulation Process

Step S701

The training data generation function 543 simulates a count at the time of low dose image capturing of the subject P and at the time of image capturing at a certain site, such as a shoulder or a pelvis, of the subject P at which X-ray absorption is large. Specifically, the training data generation function 543 acquires the original data from the memory 51. The training data generation function 543 multiplies the original data by a coefficient from 1, and simulates a low dose count P_{low}. This calculation is represented by, for example, P_{low}=a×P. That is, the training data generation function 543 performs a scaling process for reducing a value of the count in the photon count data PCD. Meanwhile, the scaling process on the value of the count is not limited to the above, and any known method is appropriately applicable.

Step S702

In the low dose CT scan, low count photon count data (low dose count) is obtained. In the low dose count, the count number is reduced, and therefore, noise relatively increases as compared to the count number. That is, the low dose count generates a large amount of noise as compared to high dose count. In view of the above, the training data generation function 543 performs the noise addition process on the low dose count. The noise addition process is a simulation of noise for the low dose count, for example. The simulation of noise is performed by using, for example, the low dose count P_{low} and a parameter θ of a function that represents the noise. If the function that represents the noise is Gaussian noise, the parameter θ corresponds to a standard deviation of the Gaussian noise. A result P_{lownoise} of the simulation of noise (hereinafter, referred to as noise-added low-dose count data) is represented by P_{lownoise}=NoiseSimlater (P_{low}, θ) by using the low dose count P_{low} and a function NoiseSimlater (P_{low}, θ) in which the parameter θ is input. Meanwhile, the simulation of noise is not limited to addition of Gaussian noise, and any known noise adding method is appropriately applicable.

Step S703

The training data generation function 543 performs a zero clipping process on the noise-added low-dose count data P_{lownoise}. The zero clipping process is, for example, a process of setting a negative value in the noise-added low-dose count data P_{lownoise} to zero (clipping to zero). Specifically, assuming that an index (subscript) for distinguishing the count number in the noise-added low-dose count data P_{lownoise} is denoted by i, and if a count number P_{lownoise_i} of the index i in the noise-added low-dose count data P_{lownoise} is a negative value (P_{lownoise_i}<0), the training data generation function 543 replaces (sets) the count number P_{lownoise_i} of the index i in the noise-added low-dose count data P_{lownoise} with (to) zero (P_{lownoise_i}=0).

In other words, at this Step, the training data generation function 543 performs the zero clipping process with respect to the negative value of the projection data. Meanwhile, at this step, the training data generation function 543 may perform a process of adopting an absolute value of the negative value of the noise-added low-dose count data P_{lownoise}, instead of performing the zero clipping. That is, if the count number P_{lownoise_i} of the index i in the noise-added low-dose count data P_{lownoise} is a negative value (P_{lownoise_i}<0, the training data generation function 543 may replace the count number P_{lownoise_i} of the index i in the noise-added low-dose count data P_{lownoise} with an absolute value (|P_{lownoise_i}|) of the count number P_{lownoise_i} of the index i in the noise-added low-dose count data P_{lownoise}.

Through the processes at Steps S701 to S703 as described above, the low count data that serves as a basis of the fourth image data is generated. By performing various kinds of preprocessing, such as logarithmic transformation, on the low count data and performing reconstruction, the fourth image data is generated. The training data generation function 543 stores third image data 3ID and fourth image data 4ID in an associated manner as a training data set in the memory 51.

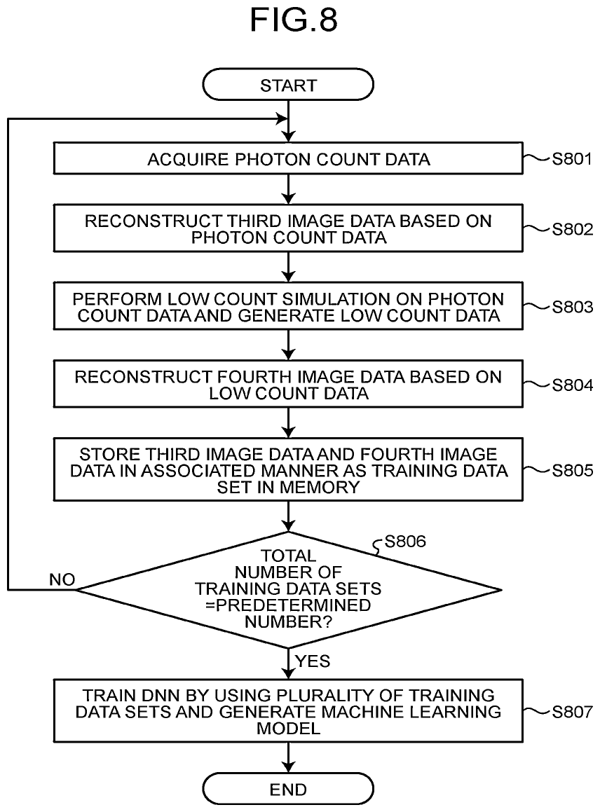

The flow of the model generation process will be described below with reference to FIG. 8. FIG. 8 is a flowchart illustrating an example of the flow of the model generation process.

Model Generation Process

Step S801

The processing circuitry 54 acquires the photon count data PCD via a communication interface (not illustrated). The processing circuitry 54 stores the acquired photon count data PCD in the memory 51. The photon count data PCD has the count number of photons that are obtained when image capturing is performed with a certain dose that is equal to or larger than a normal dose with which adequate count is measured as described above, for each of the X-ray detection elements.

Step S802

The processing circuitry 54 generates, by a reconstruction processing function (not illustrated), the third image data 3ID based on the photon count data PCD. The process related to the reconstruction processing function is the same as the reconstruction processing function 443 in the PCCT apparatus 1, and therefore, explanation thereof will be omitted.

Step S803

The processing circuitry 54 performs, by the training data generation function 543, low count simulation on the photon count data PCD and generates the low count data as illustrated in FIG. 7. The training data generation function 543 stores the generated low count data in the memory 51.

Step S804

The processing circuitry 54 generates, by the reconstruction processing function (not illustrated), the fourth image data 4ID based on the low count data.

Step S805

The processing circuitry 54 stores the third image data 3ID and the fourth image data 4ID in an associated manner as the training data set in the memory 51. The third image data 3ID corresponds to correct answer data (also referred to as teacher data) with respect to the fourth image data 4ID. The process related to the reconstruction processing function is the same as the reconstruction processing function 443 in the PCCT apparatus 1, and therefore, explanation thereof will be omitted.

Step S806

The processing circuitry 54 determines whether a total number of the training data sets stored in the memory 51 reaches a predetermined number. The predetermined number is set in advance in relation to generation of the machine learning model (the artifact reduction model ARM). If the total number of the training data sets reaches the predetermined number (Yes at Step S806), the process at Step S807 is performed. If the total number of the training data sets does not reach the predetermined number (No at Step S806), the processes from Step S801 are repeated.

Step S807

The processing circuitry 54 trains, by the model generation function 544, a model (DNN) that is not yet trained, by using each of the training data sets, and generates the artifact reduction model (trained model). That is, the model generation function 544 applies the third image data and the fourth image data to the training target DNN, trains the DNN, and generates the artifact reduction model ARM. The fourth image data in the training data set is added with noise, and therefore, the generated artifact reduction model ARM is able to reduce noise in addition to reducing an artifact.

As for the training (learning) of the DNN at this step, a well-known method is applicable, and therefore, explanation thereof will be omitted. The model generation function 544 stores the generated artifact reduction model ARM in the memory 51. The artifact reduction model ARM that is stored in the memory 51 is appropriately transmitted to, for example, the medical image capturing apparatus that has collected the original data and/or the medical image processing apparatus that performs the artifact reduction model ARM.

A model generation method implemented by the training apparatus 5 according to the embodiment as described above is a model generation method for generating a machine learning model that acquires the second image data 21D in which the low count artifact is reduced upon input of the first image data 1ID that is obtained by the X-ray CT scan, and generates a machine learning model (the artifact reduction model ARM or the trained model) by training a model that is not yet trained, by using the training data set that includes the reconstructed third image data 3ID, which is based on the projection data (the photon count data PCD) obtained by the X-ray CT scan, and the fourth image data 4ID, which is based on the projection data and which includes the generated low count artifact.

Therefore, according to the model generation method implemented by the training apparatus 5, it is possible to generate a single machine learning model (the artifact reduction model ARM) that is able to simultaneously realize reduction of an artifact and a reduction of noise with respect to the first image data that is based on the photon count data acquired with low dose.

Thus, according to the model generation method, it is possible to generate a trained model that is able to improve visibility of an object, such as an anatomical feature, in the medical image, and generate a medical image with improved image quality.

Modification

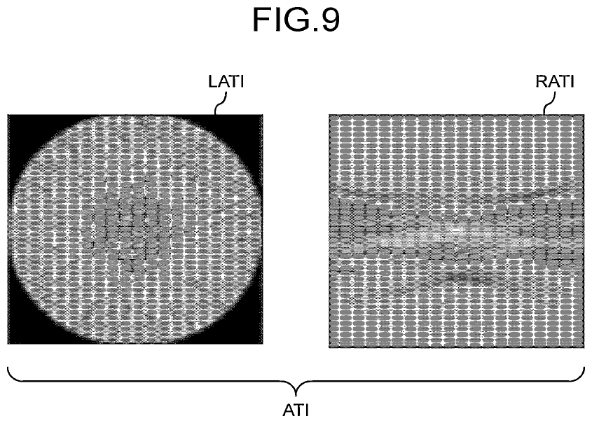

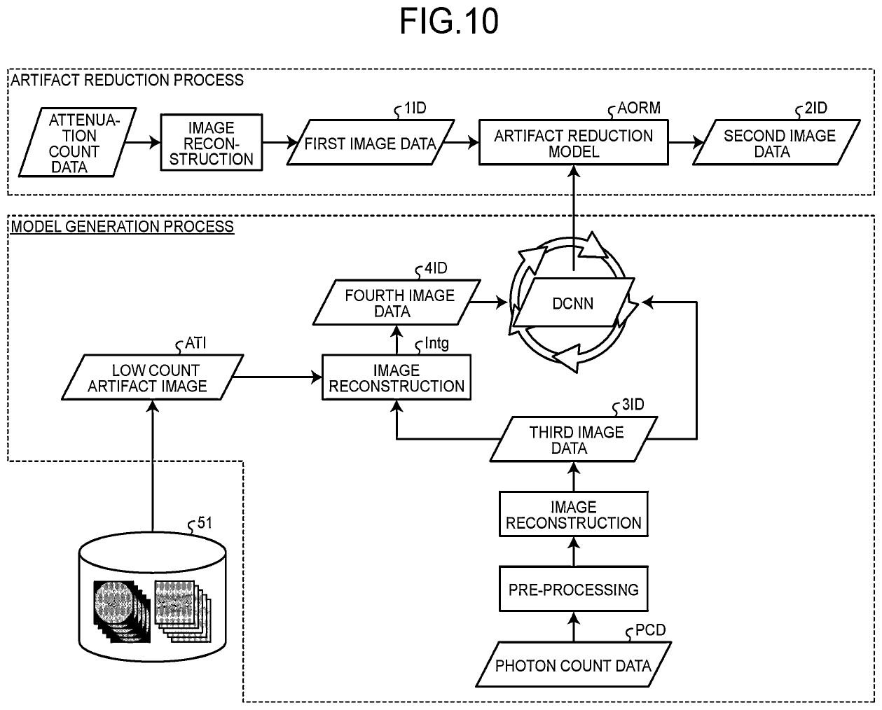

In a modification of the model generation method according to the present embodiment, the fourth image data is generated by adding an artifact image to the third image data. Therefore, in the present modification, the low count simulation process is not needed. A model generation process according to the present modification will be described below with reference to FIG. 9 and FIG. 10.

The memory 51 stores therein a plurality of low count artifact images. Each of the low count artifact images is an image that is reconstructed from count data that is generated by low-dose scan using water phantom, for example. Each of the low count artifact images includes low count artifacts with various patterns and various sizes.

FIG. 9 is a diagram illustrating an example of two low count artifact images ATI with different sizes and different patterns. A low count artifact image RATI illustrated on a right side in FIG. 9 includes, for example, two dark band artifacts along a left-right direction and streak artifacts. Further, a low count artifact image LATI on a left side in FIG. 9 includes, for example, streak artifacts in radial directions.

FIG. 10 is a diagram illustrating an example of an overview of the model generation process and the artifact reduction process. The artifact reduction process illustrated in FIG. 10 is compliant with the description in FIG. 3, and therefore, explanation thereof will be omitted. As illustrated in FIG. 10, the fourth image data 4ID is image data that is obtained by adding the low count artifact image ATI that is generated in advance to the image data that is reconstructed from the projection data.

Specifically, the processing circuitry 54 selects, by the training data generation function 543, the single low count artifact image ATI from among a plurality of low count artifact images. The training data generation function 543 reads the selected low count artifact image ATI. The training data generation function 543 adds the low count artifact image ATI read from the memory 51 to the third image data 3ID.

Specifically, the training data generation function 543 synthesizes the low count artifact image ATI and the third image data 3ID (Intg). For example, the training data generation function 543 adds the low count artifact image ATI to the third image data 3ID. Meanwhile, the training data generation function 543 may superimpose the low count artifact image ATI on the third image data 3ID. In this manner, the training data generation function 543 generates the fourth image data 4ID.

The model generation function 544 generates an artifact reduction model AORM, that is, trains the DNN by using the third image data 3ID and the fourth image data. The artifact reduction model AORM is generated in the same manner as the embodiment, and therefore, explanation thereof will be omitted.

The attenuation count data that serves as a basis for the fourth image data 4ID according to the present modification is not added with noise unlike the embodiment. Therefore, the artifact reduction model AORM that is generated in the present modification does not have the effect to reduce noise. Therefore, to reduce noise in the second image data 2ID according to the present modification, it is needed to separately apply a noise reduction model to the second image data 2ID.

Specifically, at the time of using the artifact reduction model AORM generated in the present modification (at Step S303 in the artifact reduction process), the image processing function 444 applies the noise reduction model to the second image data 2ID and acquires processed image data in which noise is reduced. In this case, at Step S304, the output function 445 outputs image data that is based on the processed image data in which noise is reduced. The image data based on the processed image data in which noise is reduced corresponds to, for example, data of an image that is obtained by causing the image processing function 444 to perform various kinds of image processing on the processed image data in which the noise is reduced.

A model generation method according to the present application example is a model generation method for generating a machine learning model that acquires the second image data 2ID in which the low count artifact is reduced upon input of the first image data 1ID that is obtained by the X-ray CT scan, and generates a machine learning model by training a model that is not yet trained, by using the training data that includes the third image data 3ID, which is reconstructed based on the projection data obtained by the X-ray CT, and the image data (the fourth image data 4ID), which is obtained by adding the low count artifact image ATI generated in advance to the image data (the third image data 3ID) that is reconstructed from the projection data. Therefore, according to the model generation method of the present modification, it is possible to easily generate a training data set, so that it is possible to efficiently generate the artifact reduction model. The other effects are the same as those of the embodiment, and therefore, explanation thereof will be omitted.

When the technical idea of the embodiment is implemented by the medical image processing apparatus, the medical image processing apparatus applies the trained machine learning model to the first image data 1ID that is obtained by the X-ray CT scan, acquires the second image data 2ID in which the low count artifact is reduced, and outputs image data based on the second image data 2ID, and, the machine learning model is trained by using the training data that includes the third image data 3ID, which is reconstructed based on the projection data that is obtained by the X-ray CT scan, and the fourth image data 4ID, which is based on the projection data and which includes a generated low count artifact. The flow and the effects of the artifact reduction process performed by the medical image processing apparatus are the same as those of the embodiment, and therefore, explanation thereof will be omitted.

When the technical idea of the embodiment is implemented by the medical image processing method, the medical image processing method applies the trained machine learning model to the first image data 1ID that is obtained by the X-ray CT scan, acquires the second image data 2ID in which the low count artifact is reduced, and outputs image data based on the second image data 2ID, and, the machine learning model is trained by using the training data that includes the third image data 3ID, which is reconstructed based on the projection data that is obtained by the X-ray CT scan, and the fourth image data 4ID, which is based on the projection data and which includes a generated low count artifact. The flow and the effects of the artifact reduction process implemented by the medical image processing method are the same as those of the embodiment, and therefore, explanation thereof will be omitted.

When the technical idea of the embodiment is implemented by a medical image processing program, the medical image processing program causes a computer to apply the trained machine learning model to the first image data 1ID that is obtained by the X-ray CT scan, acquire the second image data 2ID in which the low count artifact is reduced, and output image data based on the second image data 21D, and, the machine learning model is trained by using the training data that includes the third image data 3ID, which is reconstructed based on the projection data that is obtained by the X-ray CT scan, and the fourth image data 4ID, which is based on the projection data and which includes a generated low count artifact. The medical image processing program is stored in, for example, a computer-readable non-volatile storage medium.

For example, the artifact reduction process may be implemented by installing the medical image processing program in various server apparatuses (processing apparatuses) related to medical image processing and loading the program on the memory. In this case, the program that can cause the computer to implement the method may be distributed by being stored in a storage medium, such as a magnetic disk (hard disk or the like), an optical disk (a compact disc (CD)-ROM, a digital versatile disk (DVD), or the like), a semiconductor memory, or the like. The flow and the effects of the artifact reduction process implemented by the medical image processing program are the same as those of the embodiment, and therefore, explanation thereof will be omitted.

According to at least one embodiment or the like as described above, it is possible to generate a medical image in which an artifact is reduced at the time of low dose.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In relation to the embodiment as described above, the following notes are discloses as one and selective feature of the invention.

Note. 1

A medical image processing apparatus including
an image processing unit that acquires second image data in which a low count artifact is reduced, by applying a trained machine learning model to first image data that is obtained by X-ray CT scan; and
an output unit that outputs image data based on the second image data, wherein
the machine learning model is trained by using training data that includes third image data and fourth image data, the third image data being reconstructed based on projection data that is obtained by X-ray CT scan, the fourth image data being based on the projection data and including a generated low count artifact.

Note. 2

The fourth image data may be image data that is reconstructed after a low count simulation process is applied to the projection data and that includes a low count artifact that is artificially generated.

Note. 3

The low count simulation process may include a noise addition process and a zero clipping process with respect to a negative value of the projection data.

Note. 4

The image processing unit may acquire, by the machine learning model, the second image data in which a low count artifact and noise are reduced.

Note. 5

The fourth image data may be image data that is obtained by adding a low count artifact image that is generated in advance to image data that is reconstructed from the projection data.

Note. 6

The image processing unit may acquire processed image data in which noise is reduced, by applying a machine learning model that is trained for at least reducing noise to the second image data, and
the output unit may output image data based on the processed image data.

Note. 7

A medical image processing method including
acquiring second image data in which a low count artifact is reduced, by applying a trained machine learning model to first image data that is obtained by X-ray CT scan; and
outputting image data based on the second image data, wherein
the machine learning model is trained by using training data that includes third image data and fourth image data, the third image data being reconstructed based on projection data that is obtained by X-ray CT scan, the fourth image data being based on the projection data and including a generated low count artifact.

Note. 8

A model generation method for generating a machine learning model that acquires second image data in which a low count artifact is reduced, by applying a trained machine learning model to first image data that is obtained by X-ray CT scan, the model generation method including
generating the machine learning model by training a model that is not yet trained, by using training data that includes third image data and fourth image data, the third image data being reconstructed based on projection data that is obtained by X-ray CT scan, the fourth image data being based on the projection data and including a generated low count artifact.

What is claimed is:

1. A medical image processing apparatus comprising:
processing circuitry that
acquires second image data in which a low count artifact is reduced, by applying a trained machine learning model to first image data that is obtained by X-ray CT scan, and
outputs image data based on the second image data, wherein
the machine learning model is trained by using training data that includes third image data and fourth image data, the third image data being reconstructed based on projection data that is obtained by X-ray CT scan, the fourth image data being based on the projection data and including a generated low count artifact.

2. The medical image processing apparatus according to claim 1, wherein the fourth image data is image data that is reconstructed after a low count simulation process is applied to the projection data and that includes a low count artifact that is artificially generated.

3. The medical image processing apparatus according to claim 2, wherein the low count simulation process includes a noise addition process and a zero clipping process with respect to a negative value of the projection data.

4. The medical image processing apparatus according to claim 1, wherein the processing circuitry acquires, by the machine learning model, the second image data in which a low count artifact and noise are reduced.

5. The medical image processing apparatus according to claim 1, wherein the fourth image data is image data that is obtained by adding a low count artifact image that is generated in advance to image data that is reconstructed from the projection data.

6. The medical image processing apparatus according to claim 1, wherein the processing circuitry
acquires processed image data in which noise is reduced, by applying a machine learning model that is trained for at least reducing noise to the second image data, and
outputs image data based on the processed image data.

7. A medical image processing method comprising:
acquiring second image data in which a low count artifact is reduced, by applying a trained machine learning model to first image data that is obtained by X-ray CT scan; and
outputting image data based on the second image data, wherein
the machine learning model is trained by using training data that includes third image data and fourth image data, the third image data being reconstructed based on projection data that is obtained by X-ray CT scan, the fourth image data being based on the projection data and including a generated low count artifact.

8. A model generation method for generating a machine learning model that acquires second image data in which a low count artifact is reduced, by applying a trained machine learning model to first image data that is obtained by X-ray CT scan, the model generation method comprising:
generating the machine learning model by training a model that is not yet trained, by using training data that includes third image data and fourth image data, the third image data being reconstructed based on projection data that is obtained by X-ray CT scan, the fourth image data being based on the projection data and including a generated low count artifact.
